(19) United States
(12) Patent Application Publication
(10) Pub. No.: US 2022/0048158 A1
(43) Pub. Date: Feb. 17, 2022

(54) MACHINE TOOL HAVING A BALANCING DEVICE

(71) Applicant: Festool GmbH, Wendlingen (DE)

(72) Inventor: Harald Ruhland, Wernau (DE)

(21) Appl. No.: 17/428,160

(22) PCT Filed: Jan. 31, 2020
(86) PCT No.: PCT/EP2020/052509

§ 371 Date: Aug. 3, 2021

(30) Foreign Application Priority Data
Feb. 7, 2019 (DE) 102019103088.9

(51) Int. Cl. B24B 41/04; B24B 23/02; B24B 45/00; B25F 5/00

(52) U.S. Cl. CPC B24B 41/042; B25F 5/006; B24B 45/00; B24B 23/02

(57) ABSTRACT

A machine tool, namely a handheld machine tool or a semi-stationary machine tool, having a drivetrain, which includes a tool shaft rotatably mounted on a drive support by means of a bearing assembly and a tool holder arranged on the tool shaft for an in particular disk-like working tool, wherein the tool shaft is rotationally drivable by a drive motor of the machine tool around a rotational axis, and wherein a balancing device is arranged on the tool shaft, which includes a guide body having at least one orbital path extending around the rotational axis and at least one balancing body movably mounted in the orbital path. It is provided in the machine tool that the drive support is movably mounted on a holder of the machine tool, wherein a relative position of the drive support in relation to the holder is adjustable by the balancing device.

The invention relates to a machine tool, in particular a machine tool, having a drivetrain, which includes a tool shaft rotatably mounted on a drive support by means of a bearing arrangement and a tool holder arranged on the tool shaft for an in particular disk-like working tool, wherein the tool shaft is rotationally drivable by a drive motor of the machine tool around a rotational axis, and wherein a balancing device is arranged on the tool shaft, which includes a guide body having at least one orbital path extending around the rotational axis and at least one balancing body movably mounted in the orbital path.

Such a machine tool is explained, for example, in U.S. Pat. No. 6,974,362 B2. The machine tool is, for example, a grinding machine. A machine housing supports the bearing assembly, wherein the balancing device ensures that oscillations are transmitted to a lesser extent to the machine housing and thus to the operator.

US 2010/0068977 A1 proposes, as an alternative to a compensation system, oscillation dampers between a handle section and a lower housing part of a grinding machine.

However, the oscillation behavior of the known machine tool is not convincing.

It is therefore the object of the invention to provide a machine tool, namely a handheld machine tool or semi-stationary machine tool, having an improved balancing device.

To achieve the object, it is provided in a machine tool of the type mentioned at the outset that the drive support is movably mounted on a holder of the machine tool, wherein a relative position of the drive support in relation to the holder is adjustable by the balancing device.

It is a basic concept here that the drive support is not received fixedly and immovably in the machine housing of the machine tool, for example, but rather is movably mounted, which significantly improves the balancing behavior of the balancing device. The drive support is thus more or less decoupled from the holder and, for example, the machine housing and can be optimally balanced by the balancing device. This measure in particular facilitates the work of the user, namely because fewer vibrations are transmitted to the user. The vibration stress of the user is reduced. The machine tool includes, for example a machine housing, which provides a holder for the movably mounted drive support or forms such a holder. In particular, it is possible that the movable mounting absorbs or reduces vibrations at lower frequency.

It is preferred if the drive support is resiliently mounted with respect to the holder by a spring assembly arranged between the drive support and the holder. The spring assembly comprises, for example a buffer, in particular made of rubber, elastic plastic, or the like. However, metallic springs, in particular coiled springs, spiral springs, torsion springs, or the like are also readily possible. Springs of different types can be combined, i.e., for example, a rubber buffer or elastic plastic buffer is arranged in combination with a metallic spring, in particular a coiled spring, between the holder and the drive support. Multiple springs are preferably provided, for example at different angle positions on the outer circumference of the drive support or on the inner circumference of the holder, where the drive support is linked on the holder.

The mobility of the drive support with respect to the holder enables the drive support to vibrate with respect to the holder during operation of the machine tool, i.e., to carry out oscillating movements. It is preferred here that a first natural frequency of the drive support with respect to the holder is less than a predetermined revolution frequency or speed of the tool holder. The balancing device can thus operate optimally and transmit a minimum of imbalance forces, for example to the holder, in particular the machine housing. The tool holder thus generates vibrations at a pre-determined revolution frequency during its revolution around the rotational axis, which is determined directly by the speed of the tool holder or the revolution frequency, i.e., the time within which the tool holder rotates once around its own axis. This speed of the tool holder or the revolution frequency is, for example in a typical grinding machine or polishing machine, approximately 100 Hz to 200 Hz, in one exemplary embodiment approximately 150 Hz to 170 Hz. The natural frequency of the drive support with respect to the holder is preferably significantly less, i.e., it is, for example five times less, preferably seven times less or eight times less.

However, it can also be at least nine times less or at least 10 times less than the predetermined revolution frequency or speed of the tool holder. In the specific case, for example, at a natural speed or natural revolution frequency of the tool holder of 150 Hz, it would be approximately 15 Hz or at a revolution frequency or speed of the tool holder of 166 Hz, at approximately 17 Hz.

Insofar as imbalance forces nonetheless arise, they are only transmitted between the drive support and the holder in a reduced manner at a frequency which corresponds to the motor speed.

The revolution frequency or speed is, for example a maximum revolution frequency or maximum speed of the tool holder. The revolution frequency or speed can also be a rated revolution frequency or rated speed.

In particular, it is advantageous if the spring assembly is designed in such a way that a first natural frequency of the drive support with respect to the holder is less than the predetermined revolution frequency or speed of the tool holder.

It can be provided that the first natural frequency of the drive support with respect to the holder is set or settable by a spring constant of the spring assembly. The spring constant can thus be settable, for example, in that a spring or a damper element is set or is settable harder or softer. The spring constant can be changeable, for example, by setting a pre-tension of one or more spring elements. A positioning unit is provided for this purpose, for example, using which the spring constant is settable. In particular, such a measure is advantageous if the machine tool enables different speeds of the tool holder, i.e., the tool holder is operable at different speeds. For this purpose, the speed of the drive motor can be settable and/or a gear unit can be provided between drive motor and tool shaft, which is switchable between at least two gears, in which the speed of the tool shaft is different.

The concept having the movable mounting of the drive support on the holder can also be reasonably used in more or less autonomously operating machine tools. For example, the machine tool includes a positioning drive for positioning the tool holder for the working tool with respect to a workpiece surface for a machining of the workpiece surface by the working tool.

Alternatively or additionally, however, it is also possible that the holder includes a handle to be grasped by an operator and/or a dog part to be carried along by a positioning drive, by means of which the machine tool is positionable with respect to a workpiece surface. The positioning drive therefore does not have to form a part of the machine tool.

The handle is rod-shaped, for example. The handle can be integrally provided on a machine housing of the machine tool, for example protrude to the rear in front of a drive section of the machine housing, in which the drive support is arranged. However, it is also possible that the handle is rod-shaped, for example includes a telescopic rod or the like, so that the machine tool, in particular its drive head, where the drivetrain is arranged, can be guided along a wall surface or ceiling surface of a room by an operator.

The machine tool is in one embodiment a handheld machine tool, a so-called manual machine tool, but can also be a semi-stationary machine tool, for example a crosscut saw, circular table saw, or the like transportable to the usage location.

The machine tool can be, for example a grinding machine or polishing machine.

It is preferred if the tool holder is designed for fastening a disk tool as the working tool. The disk tool is, for example a polishing tool or grinding tool.

The machine tool can readily also be a sawing machine, milling machine, or similar other handheld or semi-stationary machine tool, however.

One advantageous concept provides that the at least one orbital path arranged on the guide body forms a first orbital path having a first radial distance with respect to the rotational axis of the balancing device, and that the balancing device comprises at least one second orbital path arranged at a longitudinal distance with respect to the rotational axis in relation to the first orbital path. This second orbital path can be provided on the same guide body, on which the first orbital path is also arranged, or also on another guide body.

It is advantageous here if the second orbital path has a second radial distance in relation to the rotational axis which is greater than the first radial distance.

Furthermore, it is expedient if the second orbital path is separated from the first orbital path, so that the balancing bodies arranged in the respective orbital path are held in their respective orbital path so they are non-adjustable between the orbital paths and/or in a cage-like manner. The balancing bodies are movably received in their respective orbital paths in this embodiment. The balancing bodies cannot move from their orbital path, in which they are movably mounted and/or revolve, into another orbital path, however. Thus, for example, a balancing body received in the or a first orbital path cannot move into the or a at least one second orbital path or a balancing body received in the at least one second orbital path cannot move into the first orbital path.

The at least one balancing body in the orbital path having greater radial distance to the rotational axis is advantageously used for roughly tuning or roughly trimming the balancing device, the at least one balancing body in the orbital path having lesser radial distance to the rotational axis expediently more or less provides the fine tuning or the fine trimming. However, at least two balancing bodies are preferred which optimally enable balancing of the drivetrain even if the drivetrain as such only has a slight imbalance already.

It is a basic concept here that multiple orbital paths, for example two orbital paths or three orbital paths, are arranged on a single guide body, which have a distance to one another with respect to the rotational axis or in the longitudinal direction of the rotational axis and moreover also have different radial distances to the rotational axis, so that different balancing functions are implementable. The balancing bodies, for example one balancing body, two balancing bodies, or further balancing bodies, are movably mounted in a respective orbital path, but remain in this orbital path and do not move into an adjacent orbital path, thus cannot be adjusted from one orbital path into the other orbital path or are held in a cage-like manner in their respective orbital path. No balancing body can thus move from the orbital path to which it is assigned and/or in which it is arranged into another orbital path, for example an adjacent orbital path.

The arrangement of multiple orbital paths in one guide body enables the guide body to be designed compactly. Furthermore, it is possible to produce the guide bodies having accurate dimensions by corresponding, for example cutting workpiece machining of a main body from which the guide body is formed, so that the balancing properties are optimally settable.

The guide body includes, for example, a main body, on which the first and the at least one second orbital path, and possibly further orbital paths, are integrally formed. For example, the main body is machined by cutting. The first and at least one second orbital path are thus formed by cutting machining, for example turning, milling, or the like, of the main body.

The main body preferably consists of metal, for example of steel, aluminum, or an alloy. However, the main body can also consist of ceramic or a plastic.

The main body is expediently held on a workpiece holder after completion of the production of the first orbital path until the beginning or the finishing of the at least one second orbital path or remains on the workpiece holder. The first orbital path is thus more or less produced with accurate dimensions, and the main body remains on or in the workpiece holder, in particular in the same chucking, in order to subsequently produce the second orbital path, advantageously also further or all orbital paths, in the same chucking or the same workpiece holder. A high level of dimensional accuracy is thus implementable. The main body preferably remains, from the beginning of the production of at least two orbital paths, expediently all orbital paths until the completion of the production of these orbital paths, in the same chucking and/or on the same workpiece holder.

The guide body can have, for example, a plate-like or disk-like or dome-like design.

Preferably, no section of the tool shaft is provided between the orbital paths of the guide body. The orbital paths of the guide body are advantageously not connected to one another by the tool shaft.

The guide body can be a guide body separate from the tool shaft. The guide body and the tool shaft are connected to one another, for example, by a plug assembly, welding, compression, or the like. The guide body advantageously has a formfitting receptacle and/or plug receptacle for the formfitting holding or plugging in of the tool shaft.

One most preferred concept provides that the guide body and the tool shaft are integral. The guide body and the tool shaft are thus produced from the same main body, for example by cutting machining, in particular turning. It is advantageous here if the tool shaft and at least one of the orbital paths, preferably all orbital paths, are produced on the main body without this being chucked differently or removed from a workpiece holder, for example, on which it is arranged for the in particular cutting production of the tool shaft and at least one orbital path.

The guide body is preferably closed by a cover. It is therefore advantageous if the guide body is closed by a cover, in particular only has a single cover, using which the first orbital path and/or the second orbital path are closed.

The orbital paths are thus produced, for example by turning of the guide body. Subsequently, the at least one balancing body is or multiple balancing bodies are inserted into the respective orbital path. The orbital paths are then closed by the single cover or multiple covers. If only a single cover is provided, it can be produced with a particularly high level of dimensional accuracy. It is also advantageous in the case of the cover if it obtains the corresponding guide contours for the orbital paths, for example by turning, in the same chucking or remaining in a workpiece holder.

The cover closes at least one orbital path, preferably multiple orbital paths or all orbital paths, of the guide body in parallel to the rotational axis and/or on the radial inside with respect to the rotational axis. For example, the radial outer guide contours of the respective orbital path are formed on the guide body and are closed laterally and/or on the radial inside by the cover.

It is to be noted here that one or more covers can be provided in order to dose a respective orbital path, i.e., an orbital path can also be dosed by multiple covers.

It is possible in principle that one or more orbital paths of the guide body are at least partially open with respect to another orbital path, for example an adjacent orbital path, for example communicate with one another fluidically or with respect to flow. The balancing bodies still remain in the respective orbital path.

One preferred concept provides, however, that at least one orbital path, preferably all orbital paths or multiple orbital paths, of the guide body is completely closed in relation to the other orbital path or in relation to the other orbital paths of the guide body. It is thus possible, for example, to keep a damping fluid, in particular oil, a grease, or the like, in the respective orbital path without it being able to move into another orbital path.

This is because one preferred concept provides that different damping fluids are arranged in at least two orbital paths of the guide body, or that only one orbital path of two orbital paths contains a damping fluid. Thus, for example, oils having different viscosity can be arranged in the respective orbital paths in order to optimally set the damping properties or balancing properties of the respective orbital path.

The orbital paths can be geometrically identical. It is furthermore possible that the orbital paths have identical sliding properties or friction properties.

A respective orbital path can comprise, for example, a spherical geometry, i.e., a type of ball channel, a U-shaped groove, a V-shaped groove, a planar surface, or the like.

However, it is also possible that surfaces which mount the respective at least one balancing body of an orbital path have different sliding properties and/or different geometries in the first orbital path and the at least one second orbital path For example, the orbital paths can consist of different materials, in particular ceramic and metal, so that different sliding properties or friction properties thus result. The geometries can also be different, which influences the movement behavior of the at least one balancing body along the surface of the respective orbital path mounting it. Thus, for example, a spherical geometry can be provided in one orbital path, while another orbital path comprises a planar surface, a V groove, or the like or is formed thereby.

The first and the at least one second orbital path comprise, for example, two orbital paths or form two orbital paths, in which balancing bodies are arranged having different geometry and/or different sliding properties and/or in different numbers and/or made of different materials. Thus, for example, ceramic balancing bodies and metal balancing bodies can be arranged in the orbital paths, so that thus different weight and different material result. Furthermore, it is possible that, for example more balancing bodies are arranged in the one orbital path than in the other orbital path.

The following measure is geometrically advantageous, in which the orbital path having the greatest radial distance to the rotational axis is closer to the tool holder and/or to the working tool than the at least one orbital path having the lesser radial distance to the rotational axis. Therefore, the orbital path having the lesser radial distance can more or less have a fine trimming property at a greater distance to the tool holder and thus at a greater distance to the working tool, while the orbital path having the greater radial distance more or less provides rough, but effective balancing.

A longitudinal distance with respect to the rotational axis between the orbital paths of the balancing device is at most three times as large, preferably only twice as large, as a longitudinal extension or height of an orbital path with respect to the rotational axis. A compact configuration of the guide body thus results with respect to the longitudinal direction of the rotational axis.

However, it is also advantageous if the greatest possible longitudinal distance is provided between the orbital paths of the balancing device with respect to the rotational axis. One advantageous measure thus provides that the minimum distance is, for example 0.5 times as much as a height of an orbital path. However, it is better if this longitudinal distance is greater, for example is 1 time or 1.5 times the longitudinal extension or the height of an orbital path.

It is to be noted here that the orbital paths preferably have the same height with respect to the rotational axis. However, it is also possible that one orbital path is taller than the other. In this case, the longitudinal distance between the orbital paths can be dimensioned both on the basis of the height of the taller orbital path and also on the basis of the height of the shorter orbital path.

An inner radius of the second orbital path is preferably greater than an outer radius of the first orbital path or approximately corresponds to the outer radius of the first orbital path. Thus, for example, different balancing properties may be optimally achieved by the two orbital paths.

The guide body has, for example, a circumferential wall extending around the rotational axis, which has a greater diameter in a region closer to the tool holder than in a region which has a greater distance to the tool holder. For example, the outer circumferential wall is conical or stepped. The guide body can have the shape of a bell or a truncated cone.

The following measure represents an invention which is independent as such in conjunction with the features of the preamble, but it can also be a refinement of the preceding embodiments. It is provided here that the guide body is a part of a fan wheel and/or that fan blades are arranged, in particular integrally, on the guide body. The guide body thus more or less has a double function, namely the function of a fan wheel, on the one hand, and the function of a central part of the balancing device, on the other hand.

The tool holder preferably has an eccentricity with respect to the rotational axis. It is also possible that the tool holder is arranged on an eccentric bearing having an eccentricity with respect to the rotational axis, so that the tool holder is eccentrically mounted with respect to the rotational axis. The working tool, for example a grinding tool or polishing tool, can thus pass through a hypercycloidal movement with respect to the rotational axis of the tool shaft.

The guide body can be arranged away from the bearing assembly rotatably mounting the tool shaft on the drive support. For example, the guide body is arranged adjacent to the bearing assembly.

One advantageous concept, which can also represent an independent invention as such in conjunction with the features of the preamble of claim 1, however, provides that a bearing, for example an eccentric bearing, is arranged in an interior of the guide body, using which the tool receptacle is rotatably mounted in relation to the rotational axis. A rotational axis of this rotational bearing is preferably eccentric to the rotational axis around which the orbital paths of the guide body are arranged. An eccentric bearing can thus be formed. The bearing is, for example, a rolling bearing, in particular a roller bearing or ball bearing. However, a plain bearing is also possible in principle. The guide body can integrally include a bearing receptacle for the rotational bearing, for example a rolling bearing. However, it is also possible that the rotational bearing, in particular rolling bearing, is arranged on a bearing receptacle of the tool shaft, which is in turn arranged in a receptacle in the interior of the guide body. The tool shaft is preferably held in a formfitting manner in the interior of the guide body.

An invention which is independent as such having the features of the preamble of claim 1, but is also an advantageous embodiment of the preceding embodiments, provides that the guide body is held on the tool shaft between two rotational bearings, using which the tool shaft is rotatably mounted on the drive support. The guide body or the balancing device can thus implement optimum balancing between these two rotational bearings.

Furthermore, it is advantageous if no bearing of the bearing assembly mounting the tool shaft on the drive support is arranged between the orbital paths of the balancing device with respect to the longitudinal extension of the rotational axis. Therefore, on the one hand, the bearing assembly and, on the other hand, the guide body or its orbital paths are provided with respect to the longitudinal extension of the rotational axis.

One preferred concept provides that the orbital paths are circular paths, which extend at a radial distance around a center axis, wherein the center axis and the rotational axis of the tool shaft are coaxial. The coaxiality is preferably an ideal coaxiality, i.e., the orbital paths extend at exactly equal radial distance around the rotational axis of the motor shaft.

The radial distance of at least one orbital path, preferably all orbital paths, is preferably essentially constant and/or varies by at most 0.05%, advantageously at most 0.07%, more advantageously at most 0.1% of its length.

An eccentricity of the first orbital path and/or the at least one second orbital path with respect to the rotational axis of the motor shaft is preferably at most 0.05%, advantageously at most 0.07%, more advantageously at most 0.1% in relation to an ideal circular path.

Such accuracies can be achieved, for example, in that the guide body or main body remains on the workpiece holder to produce the orbital paths and is not removed or repositioned until the orbital paths are produced.

One advantageous concept provides that a balancing mass which is eccentric in relation to the rotational axis is arranged fixed on the guide body. The balancing mass can form an integral part of the main body of the guide body. For example, a part can be provided on the guide body which extends over an angle segment of the guide body with respect to the rotational axis, wherein this part has a higher weight and/or a greater volume than other parts of the guide body which extend over other angle segments of the guide body. It is also possible that the balancing mass is a balancing mass separate from the guide body or its main body, which is arranged on the guide body or main body. The balancing mass is, for example, a balancing weight installed or fastened on the guide body.

Furthermore, it is possible that the balancing mass is arranged on one or more of the above-mentioned covers, using which the guide body is closed, for example forms an integral part of the cover or is fastened thereon. The balancing mass can, for example, be integrally provided on the cover or can be connected to the cover, for example screwed on, adhesively bonded, or the like.

It is particularly favorable if the balancing mass is as dose as possible to the working tool or to the tool holder.

One preferred concept provides that the balancing mass is arranged on a side of the guide body facing toward the tool holder, for example on an end face of the guide body which is opposite to the working tool during operation of the machine tool. Furthermore, it is advantageous if the balancing mass is arranged in the region of an outer circumference of the guide body having maximum radial distance to the rotational axis. It can unfold its effect particularly well there.

The tool shaft preferably forms a motor shaft on which a rotor of the drive motor is arranged. It is also possible that the tool holder is integrally arranged on the tool shaft. It is also possible that the motor shaft and the tool shaft represent two components which are separate from one another but are connected to one another, for example are connected in a rotationally coupled and/or rotationally fixed manner to one another. The tool holder can also be a component which is separate from the tool shaft but is connected to the tool shaft, in particular is connected in a rotationally coupled or rotationally fixed manner. For example, a bearing, in particular an eccentric bearing, is arranged on the tool shaft, on which the tool holder is in turn arranged.

A drive section is expediently provided on the tool shaft, to which the drive motor is rotationally coupled for rotationally driving the tool shaft, for example via an angle gear unit or another gear unit. For example, a bevel gear unit is provided, so that the drive axis of the drive motor and the rotational axis can be angled in relation to one another, in particular at right angles.

A concept shown in the drawing, which is preferred, provides a type of direct drive, however. It is preferred if a rotational axis of the drive motor and the rotational axis of the tool shaft are coaxial with one another. Furthermore, it is advantageous if the drive motor is arranged on the tool shaft or on a motor shaft connected in a rotationally fixed manner to the tool shaft.

The orbital paths of the guide body include, for example, guide walls which extend annularly around the rotational axis and have an extension in parallel to the longitudinal axis. The orbital paths are designed, for example, as ball seat channels or ball lateral surfaces.

The balancing body or balancing bodies can comprise, for example, ball sliding bodies and/or rolling bodies. Rolling bodies are preferably spherical, roll-shaped, or the like.

Exemplary embodiments of the invention are explained hereinafter on the basis of the drawings. In the figures:

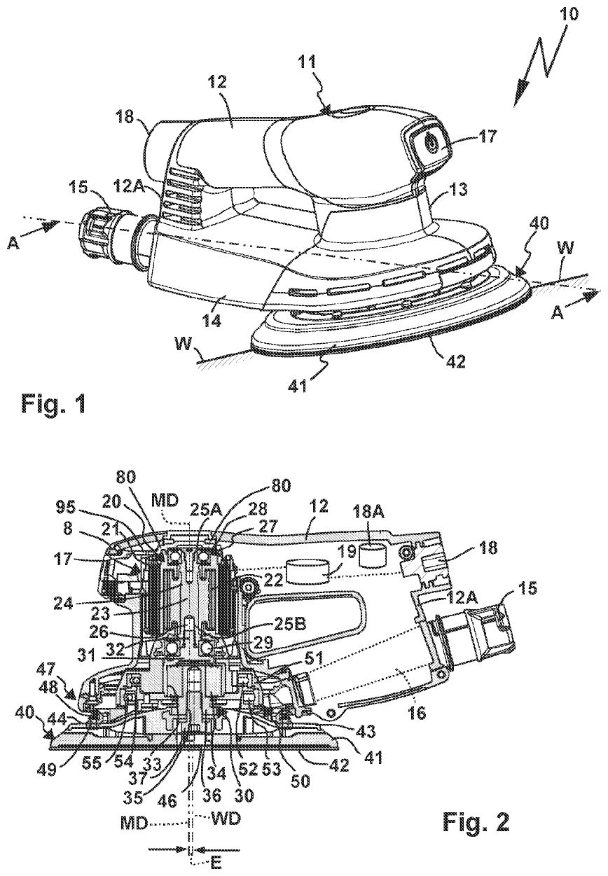

FIG. 1 shows a perspective diagonal view of a machine tool, of which in

FIG. 2 a section is shown along a section line A-A,

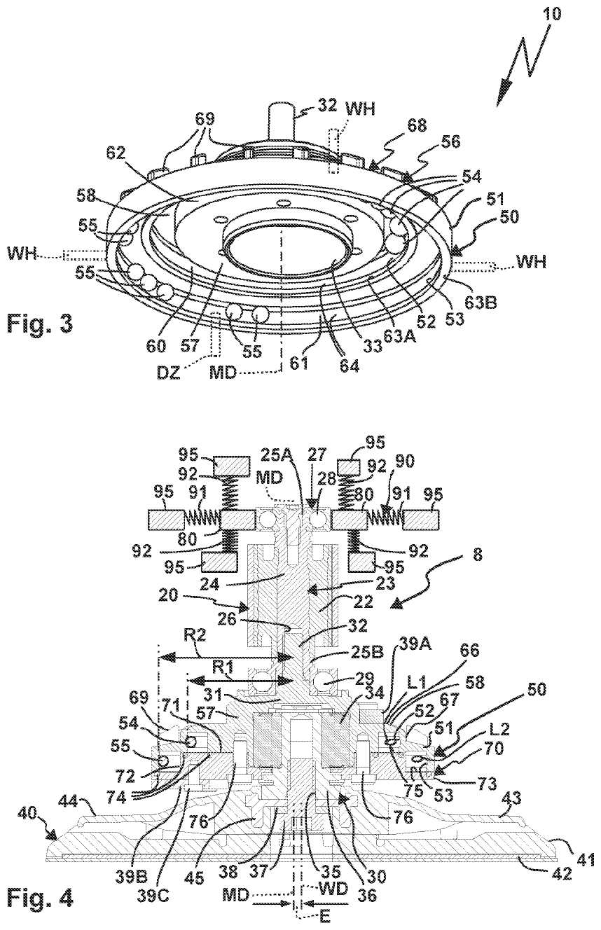

FIG. 3 shows a balancing device of the machine tool according to FIGS. 1, 2 in a perspective view diagonally from below,

FIG. 4 shows a section through a drivetrain of the machine tool according to FIGS. 1 and 2, approximately along section line A-A

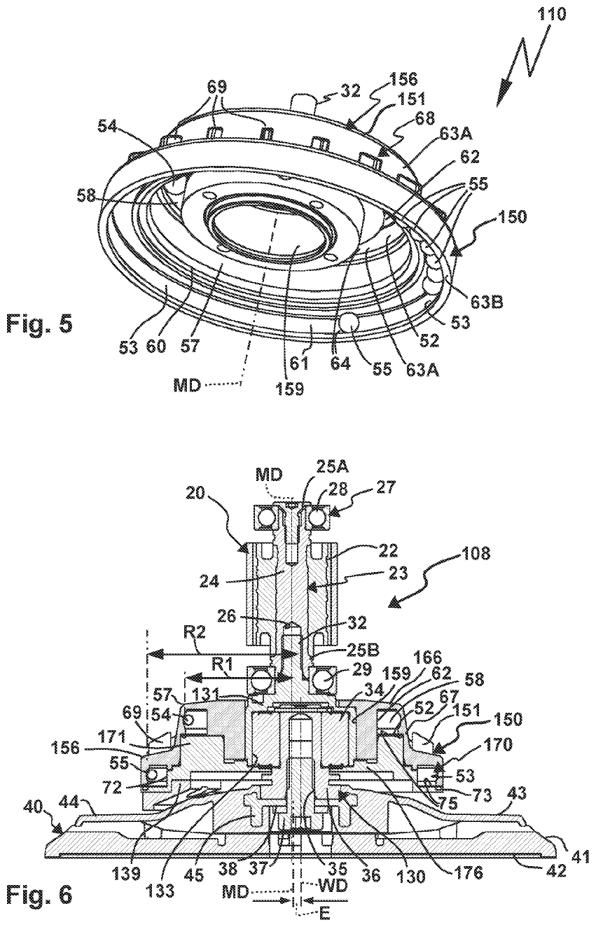

FIG. 5 shows a perspective diagonal view of a balancing device of a machine tool, the drivetrain of which is shown in cross section in FIG. 6,

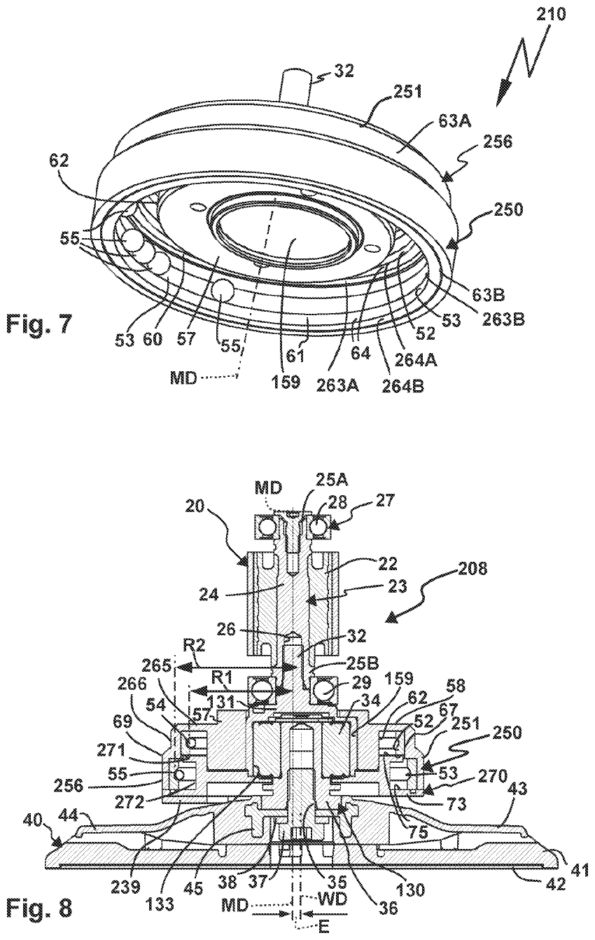

FIG. 7 shows a perspective diagonal view of a further balancing device of a machine tool, the drivetrain of which is shown in cross section in

FIG. 8

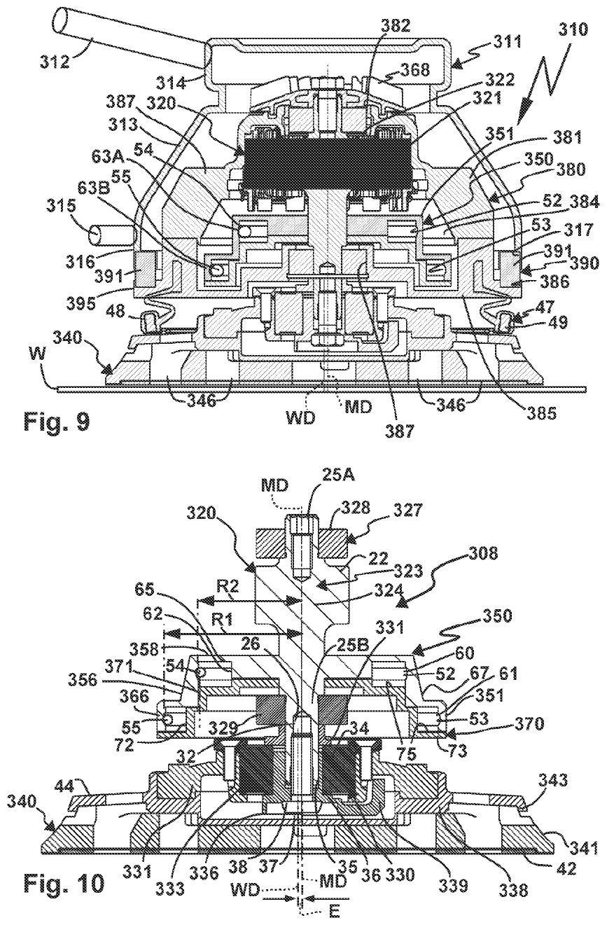

FIG. 9 shows a further machine tool in cross section, the drivetrain of which is shown in isolation in

FIG. 10

A machine tool 10 in the form of a handheld machine tool includes a machine housing 11. The machine housing 11 has a handle section 12, which is provided to be grasped and/or gripped by an operator, and which is arranged on a drive section 13 of the machine housing 11. The handle section 12 protrudes, for example at an angle, in particular approximately at right angles, from the drive section 13. The machine tool 10 can be grasped by the operator on the handle section 12 in order to machine a workpiece W, for example to grind, polish, or the like.

An exhaust air section 14 of the machine housing 11 having an exhaust air duct 16, which discharges at an exhaust fitting 15, extends adjacent to the handle section 12. Particles which arise during operation of the machine tool 10 can exit from the machine housing 11 via the exhaust fitting 15. For example, a suction hose can be connected to the exhaust fitting 15.

The exhaust air section 14 and the handle section 12 are connected to one another at their respective longitudinal end regions by a connecting section 12A and the is drive section 13.

Furthermore, a supply connection 18, for example for connecting a grid cable for connection to an electrical supply grid, for example an electrical AC grid of 110 V or 220-240 V, is provided on the machine housing 11. Additionally or alternatively to the supply connection 18, however, a connection can also be provided for an energy store, for example an electrical accumulator. Furthermore, for example, a receptacle space for a schematically indicated electrical energy store 18A, for example an electric battery, can be provided in the handle section 12, using which the machine tool 10 can be supplied with electric current. A switch 17 for switching the machine tool 10 on or off is arranged on a front side of the handheld machine tool 10 facing away from the handle section 12. The switch 17 is electrically connected, for example, to an energizing unit 19 for energizing a drive motor 20.

For example, the drive motor 20 is an electronically commutated motor, wherein other electrical or pneumatic motor types are also readily possible, for example universal motors, vane motors, or the like.

The drive motor 20 includes a stator 21 having an exciter coil assembly, which can be energized by the energizing unit 19.

The drive motor 20 forms a part of a drivetrain 8, which comprises a tool shaft 23. The tool shaft 23 is, in the drivetrain 8, at the same time a motor shaft 24 of the drive motor 20, i.e., a shaft on which the rotor 22 is arranged.

The motor shaft 24 or tool shaft 23 is rotatably mounted with respect to a drive support 80 in its upper longitudinal region 25A using a bearing 28 and at its lower longitudinal end region 25B be using a bearing 29 of a bearing assembly 27. The drive support 80 is, for example, fixedly connected to the machine housing 11 or is a permanent part of the machine housing 11. The drive support 80 can, for example, be arranged fixedly directly on the machine housing 11. However, a holder 95 for the drive support 80 can also be provided on the machine housing, for example supports protruding into the interior of the machine housing 11, which are fixedly connected to the machine housing 11 or form a part thereof.

A fastening section 26, for example a fastening receptacle, for a tool holder part 30 of the drivetrain 8 is provided at the lower longitudinal end region 25B of the motor shaft 24 or tool shaft 23. The tool holder part 30 includes a fastening section 32, for example a fastening projection, which is connected to the fastening section 26, for example pressed therein, screwed therein, or the like. The tool shaft 23 is thus also in two parts and comprises the motor shaft 24 and a tool holder shaft 31, which forms a part of the tool holder part 30.

Of course (contrary to what is shown in the drawing), an integral tool shaft is also possible, i.e., for example the motor shaft 24 and the tool holder part 30 and thus also the tool holder shaft 31 are integral. In this case, for example, the guide body 51 also explained hereinafter could be in two parts, so that it can be attached laterally to the thus integral motor shaft.

A tool bearing receptacle 33 for a tool bearing 34 is provided on the tool holder part 30, for example a plain bearing, rolling bearing, or the like. The tool bearing 34 is preferably a rolling bearing, in particular a roller bearing or ball bearing.

The motor shaft 24 or the upper section of the tool shaft 23 rotates around a motor rotational axis MD, which is referred to in simplified form hereinafter as a rotational axis, while the tool holder 34 rotates around a tool rotational axis WD. The tool rotational axis WD is eccentric to the (motor) rotational axis MD by an eccentricity E, so that the tool holder 34 is rotatably mounted within eccentricity with respect to the rotational axis MD. The tool bearing 34 thus forms an eccentric bearing. The tool bearing receptacle 33 is accordingly eccentrically arranged with respect to the (motor) rotational axis MD.

A tool holder shaft 36, which rotates around the tool rotational axis WD rotatably with respect to the motor shaft 24 or the tool holder shaft 31, is held on the tool bearing 34 or eccentric bearing. The tool holder 34 is provided on the tool holder shaft 36, for example a screw receptacle, a bayonet receptacle, or similar other fastening option for a working tool 40, which is fastenable on the tool holder 34. For example, the working tool 40 is connected by means of a fastening element 37 in the form of a screw to the tool holder 35 or installed thereon. A support body 38, for example a washer, can be provided between the fastening element 37 and a fastening section 45 of the working tool 40.

The working tool 40 is preferably a disk tool, for example a grinding disk, polishing disk, or the like. The fastening section 45 is provided on a carrier body 43 of the working tool 40. The carrier body 43 is preferably plate-like or disk-like and carries a plate body 41, for example made of foam or elastic material, on which a working surface 42, for example a grinding surface, polishing surface, or the like is provided. The working surface 42 can also represent a fastening surface for a grinding means, polishing means, or the like, however.

A surface 44 of the carrier body 43 facing away from the plate body 41 or the working surface 42 forms a brake surface, by means of which a rotation of the working tool 40 can be braked by means of a braking unit 47. The braking unit 47 comprises, for example, a collar 48 fastened fixed in place on the machine housing 11, the side of which facing toward the carrier body 43 or working tool 40 grinds along the surface 44, so that the working tool 40 is braked. Reinforcing bodies, for example made of metal, are preferably inserted into the collar 48. The collar 48 consists, for example, of rubber or similar other yielding material, so that it presses in an elastically yielding manner against the surface 44.

One or more through openings 46 for dust, which arises during operation of the working tool 40, i.e., as it grinds along a workpiece W, are provided on the working surface 42 and the plate body 41. The at least one through opening 46 communicates with an interior enclosed by the collar 48, which is in turn fluidically connected to the exhaust air duct 26, so that dust which arises in the region of the working surface 42 can flow through the through openings 46 to the exhaust fitting 15.

When the drive motor 20 drives the tool holder 35 and thus rotates the working tool 40, vibrations arise, which stress the operator who grasps the handle section 12. Such vibrations are thus undesired. The balancing device 50 explained hereinafter is provided as a remedy.

The balancing device 50 comprises a guide body 51, which is provided on the tool shaft 23. The balancing device 50 comprises a guide body 51 having a first orbital path 52 and a second orbital path 53, which are provided in path recesses 60 and 61 of the guide body 51. The guide body 51 is designed, for example like a disk or a plate.

The path recesses 60, 61 are provided on a main body 56 of the guide body 51. The main body 56 is provided integrally on the tool holder part 30. The tool holder part 30 thus integrally forms the guide body 51 or includes the path recesses 60, 61.

Balancing bodies 54, 55 are received in the orbital paths 52, 53, for example balls, rollers, rolls, or the like. During a rotation of the guide body 51 around the rotational axis MD, the balancing bodies 54, 55 can assume a temporarily fixed position with respect to the guide body 51, in particular as a compensation and/or as fine trimming for a balancing mass 39A deliberately provided on the drivetrain 8.

For example, the number of the balancing bodies 54, 55 is different, i.e., for example fewer balancing bodies 54 are arranged in the orbital path 52, for example 4 balancing bodies 54, and more balancing bodies 55 are arranged in the orbital path 53, for example 8 balancing bodies 55.

The guide body 51 includes a bearing section 57, which is provided in the region of the tool bearing receptacle 33. The orbital paths 52, 53 extend around the tool bearing receptacle 33, so that optimum balancing is provided in particular in the region of the tool bearing 34.

The guide body 51 comprises a cover wall 58 on its end face facing away from the tool holder 35, i.e. on a side of the guide body 51 facing toward the drive motor 20. The upper wall or cover wall 58 merges into an outer circumferential wall 66, on which a step 67 is provided.

Fan blades 69 of a fan wheel 68, which is integrally formed by the guide body 51, are provided on the guide body 51, for example in the region of the step 67. The fan blades 69 are provided on the radially outer edge region with respect to the rotational axis MD of the guide body 51 and generate an airflow which is suitable for cooling the drive motor 20.

The orbital paths 52, 53 include radial outer walls 63A, 63B, which are designed as ring paths 64 for the balancing bodies 54, 55. For example, the ring paths 64 include a hollow-spherical guide contour or guide surface for the balancing bodies 54, 55.

Furthermore, upper side walls 65 are provided on the path recesses 60, 61 of the guide body 51 and moreover a radial inner wall 62 is also provided in the path recess 60.

The path recesses 60, 61 are closed by a cover 70. The cover 70 closes each of the path recesses 60, 61 with a lower side wall 75, wherein it also provides a wall 72 closing on the radial inside with respect to the rotational axis D for the path recess 61.

The balancing bodies 54, 55 are held in the orbital paths 52, 53 by the cover 70 in such a way that balancing body 54 cannot reach the orbital path 53 and balancing body 55 cannot reach the orbital path 52.

Damping fluids L1 and L2, for example oils of different qualities, in particular different viscosities, are received in the path recesses 60, 61 and thus the orbital paths 52, 53. The cover 70 doses the orbital paths 52, 53 in a leaktight manner in such a way that the damping fluids L1 and L2 are enclosed in the path recesses 60, 61 and cannot move out of them.

Optionally, for example, seals 74, in particular O-rings, rubber seals, sealing coatings of the cover 70 and/or the guide body 150 in the region of surfaces at which the cover 70 and the guide body 150 press against one another, or similar other seal arrangements can be provided between the cover 70 and the guide body 150, which ensure additional fluid leak-tightness.

The wall 72 is provided on a projection 71 of the cover 70, which engages in a corresponding receptacle on the guide body 51. The side wall 75 for closing the path recess 71 is provided by a ring wall section 73, which extends around the projection 71.

Fastening means 76, for example screws or the like, are provided for fastening the cover 70, which penetrate the cover 70 and are screwed into screw receptacles (not identified in greater detail) on the guide body 51.

The first orbital path 52 has a radius R1 with respect to the rotational axis MD which is smaller than a radius R2 of the second orbital path 53. The first orbital path 52 and the second orbital path 53 are provided in the region of the step 67.

Since the orbital paths 52, 53, namely in particular the radial outer walls 63A, 63B, are provided integrally on the main body 56, a high level of dimensional accuracy is given.

In particular, it is advantageous if the main body 56 is chucked or held in a schematically shown workpiece holder WH and remains there in order to produce the orbital paths 52, 53, for example by turning by means of a cutting machining tool DZ, for example a turning tool, in particular a so-called lathe tool.

Furthermore, it is advantageous if not only the orbital paths 52, 53, but also the fastening section 32, therefore the shaft-shaped projection of the fastening section 32, are produced in the workpiece holder WH or the same chucking of the main body 56. The orbital paths 52, 53 therefore have an ideal, equal radius with respect to the rotational axis MD.

Moreover, balancing masses 39A, 39B are arranged fixed in place on the guide body 51.

The balancing mass 39A is arranged on the side of the guide body facing away from the tool holder 35 and facing toward the drive motor 20, in particular its end face. The balancing mass 39A is fastened, for example, in the region of the bearing section 52, in particular screwed on.

The balancing mass 39B is arranged on the side of the guide body 51 facing toward the tool holder 35 or the working tool 40, in particular on the cover 70. For example, the balancing mass 39B is provided on the cover 70. It can form a part of the cover 70 or, as in the exemplary embodiment, can be fastened by means of a screw 39C or a respective other fastening means, for example an adhesive bond or the like, on the cover 70. The balancing mass 39B is fastened on the guide body 51 with maximum radial distance with respect to the rotational axis MD and can thus generate an optimum imbalance, which can be compensated for by the balancing bodies 54, 55.

However, the drive support 80 can also be movably mounted in relation to the holder 95, so that it is movable, for example in parallel and/or transversely to the motor rotational axis MD. For example, a spring assembly 90 having one or more spring elements 91, 92 is arranged between the drive support 80 and the holder 95. The spring elements 91, 92 can comprise, for example coiled springs, torsion springs, or the like. The spring elements 91 support the drive support 80 transversely to the rotational axis MD with respect to the holder 95, while the spring elements 92 support the drive support 80 parallel or with a movement direction parallel to the rotational axis MD with respect to the holder 95. The spring elements 91, 92 can have different spring properties, for example different spring constants or the like, so that, for example, movements of the drive support 80 with respect to the holder 95 in parallel to the rotational axis MD are cushioned with greater spring force than movements transverse to the rotational axis MD, i.e., for example, the spring elements 91 have a lower spring stiffness than the spring elements 92.

For simplification, the embodiment having the spring assembly 90 is schematically indicated in FIG. 4 and is only provided at the bearing 28. A further movable mounting is not shown in the drawing, in particular mounting using the spring assembly 90 of the drive support 80 with respect to the holder 95 in the region of the bearing 29.

In the drivetrains 108 and 208 of machine tools 110 and 210 shown in FIGS. 5 and 6 and also 7 and 8, such a bearing concept of the respective drive support 80 with respect to the holder 95 would also be possible. In any case, the drivetrains 108 and 208 are received in the machine housing 11 equivalently to the drivetrain 8, i.e., they can be provided instead of the drivetrain 8.

Identical or similar components of the drivetrains 108 and 208 which have already been described in conjunction with the drivetrain 8 are provided with the same reference signs in the drawings and are therefore not explained in greater detail. In particular, the drivetrains 108 and 208 include the above-explained motor shaft 24 including the drive motor 20 and its components and are rotatably mounted using the bearings 28 and 29 of the bearing assembly 95 on the drive support 80. The working tool 40 is rotationally drivable using each of the drivetrains 108 and 208, which is also not explained in greater detail. The braking device 47 is also optionally provided, which is also not shown in the drawing of FIGS. 6 and 8.

A tool holder part 130, which comprises a tool holder shaft 131, is provided in the drivetrain 108. The tool holder shaft 131 is held using the above-explained fastening section 32 on the fastening section 26 of the motor shaft 24 and integrally includes a tool bearing receptacle 133 for the tool bearing 34, i.e., the eccentric bearing.

A balancing device 150 having a guide body 151, which is designed as a part separate from the tool holder shaft 131, is arranged on the tool holder shaft 131.

Similarly to the guide body 51, the guide body 151 also includes a first and a second orbital path 52, 53, in which balancing bodies 54, 55, for example balls, are mounted. Am outer circumferential wall 166 of the guide body 151 also includes a step 67, which results because the orbital path 52 has a smaller radius R1 than the second orbital path 53, which specifically has the radius R2. The balancing bodies 54 in the second orbital path having the larger radius R2 are used, as in the balancing device 50, more or less for the rough tuning or rough trimming, while the balancing bodies 54 in the first orbital path 52, i.e., having the smaller radius R1, represent a type of fine trimming.

The guide body 151 is closed by a cover 170, which includes a projection 171, which engages from the side facing away from the drive motor 20 in the guide body 151. The orbital paths 52, 53 include radial outer walls 63A, 63B, which are provided integrally on the guide body 151. An upper side wall 65 is also provided on the guide body 151, which is more or less closed on the lower side by the cover 170 or the projection 171 of the cover 170. While the orbital path 52 having the smaller radius R1 is only closed by the cover 170 from the side opposite to the upper side wall 65, the cover accordingly providing a lower side wall 75 for this purpose, the second orbital path 53 having the larger radius is not only closed by a lower side wall 75, which is provided by a ring wall section 73 of the cover 170, but also by a radial inner wall 72.

A balancing mass 139 is integrally provided on the guide body 151, namely its cover 170. The balancing mass 139 is arranged fixed on the cover 170 eccentrically to the motor rotational axis MD, and is thus arranged on the guide body 151 on which the cover 70 is arranged fixed. The cover 171 thus more or less represents an eccentric static imbalance with respect to the (motor) rotational axis MD, while the dynamic imbalance is provided by means of the balancing device 150 and thus the balancing bodies 54, 55 in the orbital paths 52 and 53 of the guide body 151.

A high accuracy with respect to the radial courses of the path recesses 60, 61, in particular the radial outer walls 63A, 63B of the guide body 151 is again ensured, specifically because both orbital paths 52 and 53 provide the respective guide contours, namely the ring paths 64 on the radial outer walls 63A, 63B, in the operating state of the guide body 151, specifically when it rotates around the (motor) rotational axis MD. The radial courses of the path recesses 60, 61 can be produced similarly as shown in conjunction with FIG. 3, for example, in that the main body 156 remains on the workpiece holder WH at least until the radial outer courses of the path recesses 60, 61 are produced, preferably the entire path recesses 60, 61.

This concept of the guide body 151 which is thus produced, so to speak, in a dimensionally accurate manner is also implemented by the guide body 251 of a balancing device 250 of the drivetrain 208. The guide body 251 includes, like the guide body 151, a shaft receptacle 159 for receiving the tool holder shaft 131, so that reference is made with respect to this embodiment to the above statements. Identical or similar parts or components of the guide bodies 251, 151 are provided with the same reference signs. However, the guide body 251, in contrast to the guide body 151, does not include fan blades 63 (which would be readily possible, however), so that it does not represent a fan wheel 68.

An outer circumferential wall 266 of the guide body 251 also includes a step 67, which more or less represents the course of the path recesses 60, 61 of the orbital paths 52, 53 of the balancing device 50 on the radial outside. This is because the orbital paths 52, 53 have a smaller radius R1 or larger radius R2, respectively, wherein the radii differ less from one another, in contrast to the above-mentioned exemplary embodiments. The guide body 251 is closed by a cover 270, which provides a lower side wall 75 with respect to each of the recesses 60 and 61 and, with respect to the path recess 161 protruding farther radially, moreover also an upper side wall 271 and a radial inner wall 272.

Integral ring paths 64 could be provided on radial outer walls 63A, 63B of the guide body 251, for example ring paths produced by turning or the like. In the present case, however, the ring paths 64 are provided on ring bodies 264A, 264B, which are arranged in the path recesses 60, 61 and are supported on the radial outer walls 63A, 63B of the guide body 251. The ring paths 64 are thus provided on radial outer walls 263A, 263B of the ring bodies 264A, 264B. The ring bodies 264A, 264B are made, for example, of hard metal or a similar other suitable material, so that they can mount the balancing bodies 54, 55 with particularly low friction, for example.

A balancing mass 239, for example a plate-shaped balancing mass 239, is arranged eccentrically to the (motor) rotational axis MD on the cover 270, for example in the region of the ring wall section 73.

The drivetrains 8, 108, 208 are preferably provided in a machine tool 10, 110, 210 designed as a handheld machine tool.

The drivetrain 308 of a machine tool 10 shown in FIGS. 9 and 10 can form a part of a handheld machine tool, namely, for example, if a handle 312, in particular a rod-shaped handle, is arranged on a machine housing 311 of the machine tool 310.

The machine housing 311 includes a drive section 313, on the end region of which a working tool 340, for example a disk tool, is arranged. The above-explained braking unit 47 having its collar 48 and the reinforcing bodies 49, which slides along a braking surface 44 of a carrier body 343 of the working tool 340, is arranged between the machine housing 311 and the working tool 340.

The working tool 340 includes a plate body 341, for example a grinding pad or the like, on which multiple through openings 346 are provided, through which the air laden with dust can move into a dust removal chamber, which is delimited by the collar 48 and is fluidically connected to an exhaust air fitting in the manner of the exhaust fitting 15 (not visible in the drawing).

In contrast to the drivetrains 8-208, in the drivetrain 308, a motor shaft 324 of a drive motor 320 is provided, on which a guide body of a balancing device, namely a guide body 351 of a balancing device 350 is arranged. The balancing device 350 is therefore a part of the motor shaft 324.

The motor shaft 324 is rotatably mounted at its longitudinal end regions 25A, 25B on bearings 328, 329 of a bearing assembly 327. The guide body 351 and thus the balancing device 350 are arranged between the bearings 328, 329. The balancing device 350 is thus located between the bearings of a tool shaft 323, the part of which forms the motor shaft 324, while in the above exemplary embodiments, the respective balancing device or the guide body is arranged laterally adjacent to the bearings of the bearing assembly, using which the drivetrain is rotatably mounted on the respective drive support.

A fan wheel 368, which extends into the exhaust air section 314 of the machine housing 311, is arranged on the longitudinal end region 25A of the motor shaft 324.

The drive motor 320 includes a rotor 322, which is arranged on the motor shaft 324 and is located in the interior of a stator 321. The longitudinal end region 25B, which is supported on the bearing 329, protrudes in front of the stator 321. The bearing 329 is located in the interior of the guide body 351, which extends more or less in a bell shape over the bearing 329. The guide body 351 includes orbital paths 52, 53 having smaller and larger radii, in which balancing bodies 54, 55, for example balls, sliding bodies, or the like, are movably accommodated. An outer circumferential wall 366 of the guide body 351 has, for example, a conical or stepped design. The guide body 351 is closed by a cover 370, which includes, for example, the above-explained side walls 75 for the path recesses 60, 61, which are provided on the guide body 351. The path recess 60 thus includes both a radial outer wall 63A, 63B for the path recess 60, 61 and also a respective upper side wall 65. Ring paths for the balancing bodies 54, 55 are provided in the radial outer walls 63A, 63B.

A fastening section 32 of a tool holder part 330 is held on a fastening section 26 of the motor shaft 324, for example plugged in, pressed in, screwed in, or the like. The tool holder part 330 includes a tool bearing receptacle 333 for a tool bearing 34. A tool holder shaft 336 having a tool holder is rotatably mounted on the tool bearing 34 around a tool rotational axis WD, which has an eccentricity E with respect to the motor rotational axis MD.

The working tool 340 is held by means of a fastening element 37, for example a screw, on the tool holder 35.

The tool holder shaft 336 includes, for example, a support body 338, on which the working tool 340 is supported. The support body 338 is, for example plate-shaped.

A balancing mass 339 is, in contrast to the preceding exemplary embodiments, not arranged on the guide body of the respective balancing device, but on the tool holder shaft 336. For example, the fastening element 37 penetrates a plate body, which represents the balancing mass 339. The balancing mass 339 is designed, for example as a plate element, which is eccentric to the motor rotational axis MD.

The drive motor 320 and the guide body 351 are held on a drive support 380. The drive support 380 includes a motor support 381, on which the bearing 328 (the upper one in the drawing) of the drive motor 320 is held, namely on a bearing receptacle 382. The upper part or the motor support 381 is, for example bell-shaped. In any case, a side wall section 383 extends laterally past the drive motor 320, in particular the stator 321, and is closed on its free side facing away from the bearing receptacle 382 by a cover 385 of the drive support 380. The cover 385 and the motor support 381 enclose an interior 384, in which the guide body 351 is rotatably mounted.

A bearing receptacle 347 for the bearing 329 is provided on the cover 385. The cover 385 and the motor support 381 are fixedly connected to one another, so that the two bearings 328, 329 are held rigidly in the drive support 380. The balancing device 350 can thus optimally remedy the imbalance situation in the region of the drive support 380, i.e., unfold an optimum balancing performance with respect to the drive support 380.

This effect is also reinforced in that the drive support 380 is not fixedly connected to the machine housing 311, but is movably mounted thereon. The machine housing 311 represents a holder 395 for the drive support 380, wherein the drive support 380 is movably mounted in relation to the holder 395, in particular having a movement component parallel to and/or a movement component transverse to the (motor) rotational axis MD.

A spring assembly 390 is arranged between the drive support 380 and the holder 395. The spring assembly 390 comprises spring elements 391, for example rubber buffers or other elastic buffer elements. The spring elements 391 are preferably designed to be block-like. The spring elements 391 comprise, for example essentially cuboid elements. A spring element 391 in the form, for example of a ring could also readily be provided, which is supported on one side on the machine housing 311 and thus on the holder 395, and on the other side on the drive support 380. At least one receptacle 317, for example a pocket, ring groove, or the like is provided for the spring element or elements 391 on the machine housing 311 and thus the holder 395. At least one receptacle, namely a receptacle 386, for example a pocket, ring groove, or the like, is provided on the drive support 380 for the at least one spring element 391. The receptacles 317, 386 are opposite to one another.

The drive support 380 can thus vibrate or oscillate within the machine housing 311, which significantly increases the balancing quality of the balancing device 350. This situation is already advantageous as such if the machine tool 310 is operated as a handheld machine tool, i.e., the operator grasps the machine housing 311 directly or uses the handle 312, for example. This technology proves to be particularly advantageous in a situation in which the machine housing 311 is held rigidly or vibration-fixed, i.e., the machine housing 311 has no or only slight mobility in relation to the fixed reference body. Such a reference body is, for example, a positioning drive 315, using which the machine tool 311 is movable along an underlying surface, for example the workpiece W. The positioning drive 315 is, for example, a drive motor, a cable pull drive, or similar other positioning means which are fixed on the machine housing 311 and thus on the holder 315 in order to move the holder 395 in relation to a surface which is to be machined by the machine tool 310. The positioning drive 315 is schematically shown.

It is also advantageous in the case of the guide bodies 151, 251, 351 if respective orbital paths 52, 53 are arranged on the same main body 156, 256, 356. In the case of the guide body 351, it is furthermore expedient that the motor shaft 324 and the guide body 351 are also parts of the same main body 356. In particular, it is advantageous if the respective main bodies 156, 256, 356, as explained with reference to the main body 56, remain on the workpiece holder WH until, for example both orbital paths 52, 53 have been produced in each case. In the case of the main body 356, it is furthermore advantageous if the motor shaft 324 is produced, in particular in the region of the bearings 328, 329 and the orbital paths 52, 53, without the main body 356 being removed from the work piece holder WH.

| | | | |
|---|---|---|---|
| 8 | 108 208 308 drivetrain | 56 | 156, 256, 356 main body |
| 10 | machine tool | 57 | bearing section |
| 11 | machine housing | 58 | upper wall, cover wall |
| 12 | handle section 12A connecting | 159 | shaft receptacle for 131 |
| | section | | |
| 13 | drive section | | |
| 14 | exhaust air section | | |
| 15 | exhaust fitting | | |
| 16 | exhaust air duct | | |
| 17 | switch | 60 | path recess of first orbital path |
| 18 | supply connection | 61 | path recess of second orbital path |
| 19 | energizing unit | 62 | radial inner wall |
| 20 | 320 drive motor | 63A 63B | radial outer wall |
| 21 | 321 stator | 64 | ring path |
| 22 | 322 rotor | 65 | upper side wall |
| 23 | 323 tool shaft | 66 | 166 266 366 outer circumferential |
| | | | wall |
| 24 | motor shaft | 67 | step |
| 25A 25B | upper lower longitudinal end | 68 | 368 fan wheel |
| | region | | |
| 26 | fastening section | 69 | fan blades |
| 27 | bearing assembly | 70 | 170, 270, 370 cover |
| 28 | upper bearing | 71 | 171 271 371 projection |
| 29 | lower bearing | 72 | radial inner wall |
| 30 | 130 330 tool holder part | 73 | ring wall section |
| 31 | 131 331 tool holder shaft | 74 | seals |
| 32 | fastening section | 75 | lower side wall |
| 33 | 133 333 tool bearing receptacle | 76 | fastening means/screws |
| 34 | tool bearing = eccentric bearing | 176 | support section for 34 |
| 35 | tool holder | | |
| 36 | tool holder shaft eccentric shaft | 80 | 380 drive support |
| 37 | fastening element screw | 317 | receptacle of spring element 391 |
| 38 | support body/washer for 37 | 381 | motor support upper part |
| 39A 39B | 139 239 339 balancing mass | 382 | bearing receptacle for 28 |
| 39C | screw | 383 | side wall section |
| 40 | working tool | 384 | interior |
| 41 | plate body | 385 | cover lower part |
| 42 | work surface | 386 | receptacle of spring element 391 |
| 43 | carrier body | 93 | |
| 44 | (braking) surface | 387 | bearing receptacle for 28 |
| 45 | fastening section | 90 | 390 spring assembly |
| 46 | through opening(s) | 91 | 391 spring element/buffer |
| 47 | braking unit | 92 | spring element |
| 48 | collar | 95 | 395 mount |
| 49 | reinforcing body | 312 | handle |
| 50 | 150 250 balancing device | 315 | positioning drive |
| 51 | 151 251 guide body | W | workpiece |
| 52 | 1. orbital path (52, 53) | MD | (motor) rotational axis |
| 33 | 2. orbital path (52, 53) | WD | tool rotational axis |
| 54 | balancing body of first orbital path | E | eccentricity |
| | (52) | | |
| 55 | balancing body of second orbital | L1 L2 | damping fluid |
| | path (53) | | |

1. A machine tool, having a drivetrain, which includes a tool shaft rotatably mounted on a drive support by means of a bearing assembly and a tool holder, arranged on the tool shaft, wherein the tool shaft is rotationally drivable by a drive motor of the machine tool around a rotational axis, and wherein a balancing device is arranged on the tool shaft, which includes a guide body having at least one orbital path extending around the rotational axis and at least one balancing body movably mounted in the orbital path and wherein the drive support is movably mounted on a holder of the machine tool, wherein a relative position of the drive support in relation to the holder is adjustable by the balancing device.

2. The machine tool as claimed in claim 1, wherein the drive support is resiliently mounted with respect to the holder by a spring assembly arranged between the drive support and the holder.

3. The machine tool as claimed in claim 2, wherein the spring assembly includes at least one buffer.

4. The machine tool as claimed in claim 1, wherein a first natural frequency of the drive support with respect to the holder is less than a predetermined revolution frequency or speed of the tool holder.

5. The machine tool as claimed in claim 4, wherein the first natural frequency is at least five times less than the predetermined revolution frequency or speed of the tool holder.

6. The machine tool as claimed in claim 4, wherein the predetermined revolution frequency or speed is a maximum revolution frequency or maximum speed or a rated revolution frequency or rated speed.

7. The machine tool as claimed in claim 4, wherein the first natural frequency of the drive support with respect to the holder is set or settable by a spring constant of the spring assembly.

8. The machine tool according to claim 1, further comprising a machine housing, on which the holder is arranged or which forms the holder.

9. The machine tool according to claim 1, wherein the holder includes a handle to be grasped by an operator and/or a dog part to be carried along by a positioning drive, by means of which the machine tool can be positioned with respect to a workpiece surface.

10. The machine tool as claimed in claim 1, further comprising a positioning drive for positioning the tool holder for the working tool with respect to a workpiece surface for machining the workpiece surface by the working tool.

11. The machine tool as claimed in claim 1, wherein the machine tool is a grinding machine or a polishing machine and/or the tool holder is designed for fastening a disk tool as the working tool.

12. The machine tool as claimed in claim 1, wherein the at least one orbital path arranged on the guide body comprises a first orbital path having a first radial distance to the rotational axis of the balancing device and the balancing device comprises at least one second orbital path, which is at a longitudinal distance with respect to the rotational axis in relation to the first orbital path.

13. The machine tool according to claim 12, wherein the at least one second orbital path has a greater second radial distance to the rotational axis than the first radial distance.

14. The machine tool according to claim 12, wherein the at least one second orbital path is separated from the first orbital path, so that the balancing bodies arranged in the respective orbital path are held so they are non-adjustable between the orbital paths and/or in a cage-like manner in their respective orbital path.

15. The machine tool as claimed in claim 12, wherein the guide body includes a main body, on which the first and at least one second orbital path are integrally formed, wherein the first and the at least one second orbital path are produced by cutting machining of the main body, wherein the main body remains on a workpiece holder after completion of the production of the first orbital path until the beginning of the production of the at least second orbital path.

16. The machine tool as claimed in claim 1, wherein the guide body integrally including the orbital paths, and the tool shaft are integral.

17. The machine tool as claimed in claim 1, wherein the guide body includes a cover, using which the first orbital path and/or the second orbital path are closed, wherein the cover closes at least one orbital path of the guide body parallel to the rotational axis and/or on the radial inside with respect to the rotational axis.

18. The machine tool as claimed in claim 1, wherein at least one orbital path of the guide body is completely closed in relation to the or another orbital path or the other orbital paths of the guide body.

19. The machine tool as claimed in claim 1, wherein different damping fluids are arranged in at least two orbital paths of the guide body, and/or wherein, of at least two orbital paths of the guide body, only one orbital path has a damping fluid.

20. The machine tool as claimed in claim 1, wherein surfaces, which mount the respective at least one balancing body, of the first orbital path and the at least one second orbital path have different sliding properties and/or different geometries.

21. The machine tool as claimed in claim 1, wherein the first and the at least one second orbital path comprise or form at least two orbital paths, in which balancing bodies are arranged having different geometry and/or different weight and/or different sliding properties and/or in different numbers and/or made of different materials.

22. The machine tool as claimed in claim 1, wherein the orbital path having the greatest radial distance to the rotational axis is closer to the tool holder and/or to the working tool than the at least one orbital path having a lesser radial distance is to the rotational axis.

23. The machine tool as claimed in claim 1, wherein a longitudinal distance with respect to the rotational axis between the orbital paths of the balancing device is at most three times as large as a longitudinal extension or height of an orbital path with respect to the rotational axis.

24. The machine tool as claimed in claim 1, wherein an inner radius of the at least one second orbital path is greater than an outer radius of the first orbital path or approximately corresponds to the outer radius of the first orbital path.

25. The machine tool as claimed in claim 1, wherein the guide body has an outer circumferential wall, which extends around the rotational axis, and which has a greater diameter in a region closer to the tool holder than in a region which has a greater distance to the tool holder, and/or wherein the guide body has the form of a bell or a truncated cone.

26. The machine tool as claimed in claim 1, wherein the guide body is a part of a fan wheel and/or wherein fan blades are arranged, on the guide body.

27. The machine tool as claimed in claim 1, wherein the tool holder has an eccentricity with respect to the rotational axis and/or is arranged on an eccentric bearing having an eccentricity with respect to the rotational axis, so that the tool holder is eccentrically mounted in relation to the rotational axis.

28. The machine tool as claimed in claim 1, wherein a bearing, using which the tool holder is rotatably mounted relative to the rotational axis, is arranged in an interior of the guide body.

29. The machine tool as claimed in claim 1, wherein the guide body is arranged adjacent to the bearing assembly rotatably mounting the tool shaft on the drive support.

30. The machine tool as claimed in claim 1, wherein the guide body is held on the tool shaft between two rotational bearings, using which the tool shaft is rotatably mounted on the drive support.

31. The machine tool as claimed in claim 1, wherein no bearing of the bearing assembly mounting the tool shaft on the drive support is arranged between the orbital paths of the balancing device with respect to the longitudinal extension of the rotational axis.

32. The machine tool as claimed in claim 1, wherein the orbital paths are circular paths, which extend at a radial distance around a center axis, wherein the center axis and the rotational axis of the tool shaft are coaxial.

33. The machine tool as claimed in claim 32, wherein the radial distance of the first orbital path and/or the at least one second orbital path varies by at most 0.05%, of its length and/or has an eccentricity of the first orbital path and/or the at least one second orbital path with respect to the rotational axis of the motor shaft of at most 0.05%, in relation to an ideal circular path.

34. The machine tool as claimed in claim 1, wherein a balancing mass eccentric in relation to the rotational axis is arranged fixedly on the guide body.

35. The machine tool as claimed in claim 32, wherein the balancing mass is arranged on a side of the guide body facing toward the tool holder and/or in the region of an outer circumference of the guide body having maximum radial distance to the rotational axis.

36. The machine tool as claimed in claim 1, wherein the tool shaft forms a motor shaft, on which a rotor of the drive motor is arranged, and/or wherein the tool holder is integrally arranged on the tool shaft.

37. The machine tool as claimed in claim 1, wherein the tool shaft includes a drive section, to which the drive motor is rotationally coupled to rotationally drive the tool shaft.
